(19) United States
(12) Patent Application Publication
(10) Pub. No.: US 2026/0008970 A1
(43) Pub. Date: Jan. 8, 2026

(54) SYSTEMS AND METHODS FOR PROCESSING PYROLYSIS OIL

(71) Applicant: SABIC Global Technologies B.V., Bergen op Zoom (NL)

(72) Inventors: Safa FARAJZADEH BIBALAN, Geleen (NL); Fabrice CUOQ, Geleen (NL)

(73) Assignee: SABIC Global Technologies B.V., Bergen op Zoom (NL)

(21) Appl. No.: 19/119,827

(22) PCT Filed: Oct. 10, 2023
(86) PCT No.: PCT/IB2023/060162

§ 371 Date: Apr. 10, 2025

(30) Foreign Application Priority Data
Oct. 26, 2022 (EP) 22203852.3

(51) Int. Cl. C10G 73/32

(52) U.S. Cl. CPC C10G 73/32; C10G 2300/1003; C10G 2300/4006; C10G 2300/4068; C10G 2400/20

(57) ABSTRACT

A method of removing paraffinic wax from pyrolysis oil that includes flowing pyrolysis oil into a tank and reducing the temperature of the pyrolysis oil to a temperature that causes the paraffinic wax that is in solution in the pyrolysis oil to precipitate and form (1) paraffinic wax in solid form and (2) remaining pyrolysis oil in liquid form. The method further includes pumping the remaining pyrolysis oil from the tank to a first location. The method then involves heating the paraffinic wax in solid form to form paraffinic wax in liquid form and pumping the paraffinic wax in liquid form to a second location. In this way, the paraffinic wax and the remaining pyrolysis oil can be processed separately according to their respective properties.

### CROSS REFERENCE TO RELATED APPLICATIONS

This application claims the benefit of priority of European Patent Application No. 22203852.3, filed Oct. 26, 2022, which is hereby incorporated by reference in its entirety.

### FIELD OF INVENTION

The present invention generally relates to processing of pyrolysis oil. More specifically, the present invention relates to the removal of wax from pyrolysis oil, cracking the remaining pyrolysis oil to produce olefins, and/or cracking the paraffinic wax to produce olefins.

### BACKGROUND OF THE INVENTION

Chemical recycling of mixed plastic waste produces material that serves as raw material for producing olefins. This chemical recycling includes pyrolysis of the mixed plastic waste to produce a hydrocarbon liquid known as pyrolysis oil (pyoil). Pyoil normally has a relatively high cold filter plugging point (CFPP), which can be attributed to the presence of heavy paraffinic compounds (wax) in the pyrolysis oil. Paraffinic wax consists of straight chain saturated hydrocarbons with carbon atoms ranging from C18 to C36. Paraffinic wax comprises mostly normal paraffins (80-90 wt. %) and further comprises branched paraffins (iso-paraffins) and cycloparaffins (collectively 10-20 wt. %). The paraffinic wax in pyrolysis oil can be considered heavy tail, which is known to be an issue for steam cracking furnaces. Thus, there is a need to reduce the amount of paraffinic wax in pyrolysis oil that is destined for cracking.

### BRIEF SUMMARY OF THE INVENTION

The present inventors have discovered systems and methods for addressing at least some of the problems associated with respect to pyrolysis oil processing. According to embodiments of the invention, heavy paraffinic compounds that are included in pyrolysis oil tend to form solid wax at lower ambient temperature. Thus, according to embodiments of the invention, the heavy paraffinic material in pyrolysis oil can be caused to form solids and then the solids can be separated from the lighter liquid portion of the pyrolysis oil. The lighter portion of the pyrolysis oil and the heavier paraffinic wax can then be processed separately.

Embodiments of the invention include a method of processing pyrolysis oil. The method includes flowing pyrolysis oil into a tank and reducing the temperature of the pyrolysis oil to a temperature that causes paraffinic wax that is in solution in the pyrolysis oil to precipitate and form (1) paraffinic wax in solid form and (2) remaining pyrolysis oil in liquid form. The method further includes pumping the remaining pyrolysis oil from the tank to a first location. The method then involves heating the paraffinic wax in solid form to form paraffinic wax in liquid form and pumping the paraffinic wax in liquid form to a second location.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

For the purposes of this disclosure, “X, Y, and/or Z” can be construed as X only, Y only, Z only, or any combination of two or more items X, Y, and Z (e.g., XYZ, XY, XZ, YZ).

The terms “wt. %”, “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process of the present invention can “comprise,” “consist essentially of,” or “consist of” particular ingredients, components, compositions, etc., disclosed throughout the specification.

The term “primarily,” as that term is used in the specification and/or claims, means greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

For a more complete understanding, reference is now made to the following descriptions taken in conjunction with the accompanying drawings, in which:

FIG. 1 shows a system for processing pyrolysis oil, according to embodiments of the invention;

FIG. 2 shows a method of processing pyrolysis oil, according to embodiments of the invention;

FIG. 3 shows normal paraffins distribution change due to freezing experiment (Crystal phase vs. Supernatant phase);

FIG. 4 shows iso paraffins distribution change due to freezing experiment (Crystal phase vs. Supernatant phase);

FIG. 5 shows normal naphthenes distribution change due to freezing experiment (Crystal phase vs. Supernatant phase);

FIG. 6 shows iso naphthenes distribution change due to freezing experiment (Crystal phase vs. Supernatant phase);

FIG. 7 shows aromatics distribution change due to freezing experiment (Crystal phase vs. Supernatant phase); and

FIG. 8 shows total carbon distribution change due to freezing experiment (Crystal phase vs. Supernatant phase).

### DETAILED DESCRIPTION OF THE INVENTION

Embodiments of the invention, as described herein, include a process for removing paraffinic wax from pyrolysis oil. This removal of paraffinic wax is advantageous because it makes the pyrolysis oil lighter and hence a more suitable feedstock for steam crackers. This paraffinic wax can be considered as heavy tail, which is known to be an issue for steam cracking furnaces. By removing the paraffinic wax, according to embodiments of the invention, there can be an optimization of the processing of pyrolysis oil components. The removed paraffinic wax and the remaining pyrolysis oil, according to embodiments of the invention, can be processed differently and according to the most effective process for each. For example, the paraffinic wax and the remaining pyrolysis oil can be processed in two different furnaces with different severities. Processing the paraffinic wax and the remaining pyrolysis oil provides more flexibility in controlling the products slate. Each steam cracker, for instance, can be adapted to market demands in order to optimize steam cracker margin.

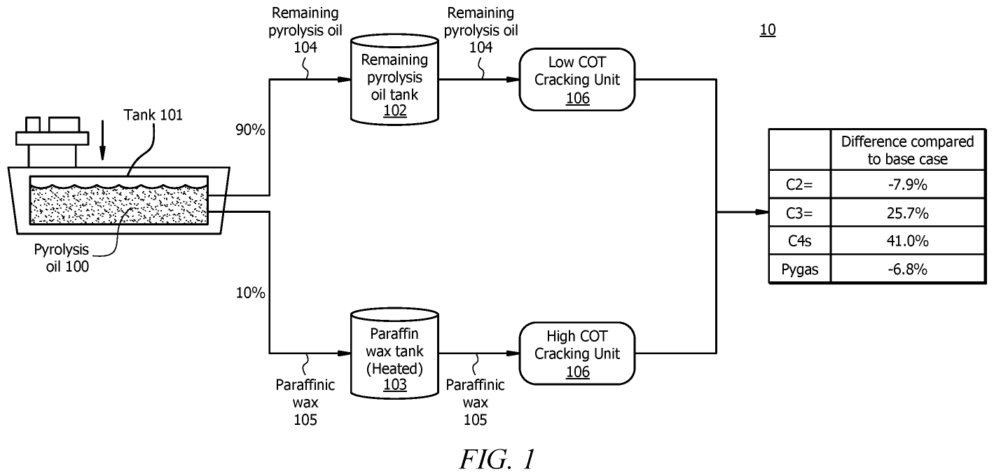

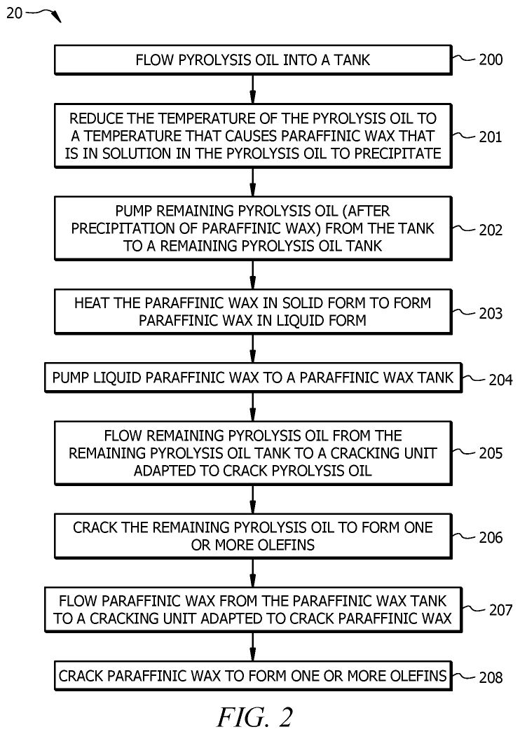

FIG. 1 shows system 10 for processing pyrolysis oil, according to embodiments of the invention. FIG. 2 shows method 20 for processing pyrolysis oil, according to embodiments of the invention. In embodiments of the invention, method 20 is implemented using system 10.

System 10, according to embodiments of the invention, includes pyrolysis oil 100 stored in tank 101, as shown in FIG. 1. Tank 101, in embodiments of the invention, can be a stationary tank or a mobile tank located in a bulk transportation vessel or vehicle. In embodiments of the invention, tank 101 is adapted to cool and/or heat material stored in tank 101. For example, tank 101, in embodiments of the invention, is equipped with a circulating coolant that cools (a) the tank and/or (b) coils within the tank so as to, in turn, cool pyrolysis oil 100. Alternatively or additionally, in embodiments of the invention, tank 101 may be equipped with heating equipment to heat paraffinic wax that may have precipitated in tank 101.

According to embodiments of the invention, tank 101 is in fluid communication with (1) remaining pyrolysis oil tank 102, such that remaining pyrolysis oil 104 can flow from tank 101 to remaining pyrolysis oil tank 102 and (2) paraffinic wax tank 103, such that paraffinic wax 105 can flow from tank 101 to paraffinic wax tank 103. Paraffinic wax tank 103, in embodiments of the invention, is a heated tank. In embodiments of the invention, remaining pyrolysis oil tank 102 is in fluid communication with a cracking unit with a low cracking operating temperature (COT), i.e., low COT cracking unit 106, such that remaining pyrolysis oil 104 can flow from remaining pyrolysis oil tank 102 to low COT cracking unit 106. Paraffinic wax tank 103 is in fluid communication with high COT cracking unit 107, in embodiments of the invention, such that paraffinic wax 105 can flow from paraffinic wax tank 103 to high COT cracking unit 107. According to embodiments of the invention, low COT cracking unit 106 and high COT cracking unit 107 have different cracking operating temperatures. For example, according to embodiments of the invention, low COT cracking unit 106 has a COT in a range of 775 to 825° C., including any of ranges 775 to 780° C., 780 to 785° C., 785 to 790° C., 790 to 795° C., 795 to 800° C., 800 to 805° C., 805 to 810° C., 810 to 815° C., 815 to 820° C., and 820 to 825° C., and high COT cracking unit 107 has a COT in a range of 826 to 875° C., including any of ranges 826 to 830° C., 830 to 835° C., 835 to 840° C., 840 to 845° C., 845 to 850° C., 850 to 855° C., 855 to 860° C., 860 to 865° C., 865 to 870° C., and 870 to 875° C.

Method 20, as shown in FIG. 2, includes, at block 200, flowing pyrolysis oil 100 into tank 101, in embodiments of the invention. Method 20 further includes, at block 201, reducing the temperature of pyrolysis oil 100 to a temperature that causes paraffinic wax 105 that is in solution in pyrolysis oil 100 to precipitate and form (1) paraffinic wax 105 in solid form and (2) remaining pyrolysis oil 104 in liquid form. In embodiments of the invention, pyrolysis oil 100 is reduced to a temperature of −10° C. to 2° C., including any of ranges −10 to −8° C., −8 to −6° C., −6 to −4° C., −4 to −2° C., −2 to 0° C., 0 to 2° C., to precipitate paraffinic wax 105. According to embodiments of the invention, the reducing of the temperature of pyrolysis oil 100 comprises cooling, with a circulating coolant, (1) the tank and/or (2) coils within the tank so as to, in turn, cool pyrolysis oil 100. Method 20, at block 202, according to embodiments of the invention, includes pumping remaining pyrolysis oil 104 from tank 101 to a first location—remaining pyrolysis tank 102 (a feed tank for low COT cracking unit 106). According to embodiments of the invention, because of the separation paraffinic wax 105 from pyrolysis oil 100, remaining pyrolysis oil 104 can have a cold filter plugging point (CFPP) of −5 to 5° C., including any of ranges −5 to −4° C., −4 to −3° C., −3 to −2° C., −2 to −1° C., −1 to 0° C., 0 to 1° C., 1 to 2° C., 2 to 3° C., 3 to 4° C., and 4 to 5° C. In embodiments of the invention, the pumping at block 202 of remaining pyrolysis oil 104 is from a level no lower than 1 to 10 inches above the bottom of tank 101. At block 203, method 20 further includes heating, in tank 101, paraffinic wax 105 in solid form to form paraffinic wax 105 in liquid form. According to embodiments of the invention, paraffinic wax 105 comprises straight chain saturated hydrocarbons with carbons atoms ranging from C18 to C36 and/or paraffinic wax 105 comprises 80-90 wt. % normal paraffin content and 10-20 wt. %, branched paraffins (iso-paraffins) and cycloparaffins. Method 20 involves at block 204, pumping paraffinic wax 105 in liquid form to a second location-paraffinic wax tank 103 (a feed tank for high COT cracking unit 107).

Method 20, according to embodiments of the invention, includes, at block 205, flowing remaining pyrolysis oil 104 from remaining pyrolysis oil tank 102 to low COT cracking unit 106, which is adapted to crack pyrolysis oil. And at block 206, method 20 involves cracking remaining pyrolysis oil 104 at a COT of 775 to 825° C. to form one or more olefins, in embodiments of the invention. The one or more olefins formed at block 206 can comprise, according to embodiments of the invention, ethylene and/or propylene.

Method 20, according to embodiments of the invention, includes, at block 207, flowing paraffinic wax 105 from paraffinic wax tank 103 to high COT cracking unit 107, which is adapted to crack paraffinic wax. And at block 208, method 20 involves cracking paraffinic wax 105 at a COT of 826 to 875° C. to form one or more olefins, in embodiments of the invention. The one or more olefins formed at block 208 can comprise, according to embodiments of the invention, ethylene and/or propylene.

Although embodiments of the present invention have been described with reference to blocks of FIG. 2 it should be appreciated that operation of the present invention is not limited to the particular blocks and/or the particular order of the blocks illustrated in FIG. 2. Accordingly, embodiments of the invention may provide functionality as described herein using various blocks in a sequence different than that of FIG. 2.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown.

As part of the disclosure of the present invention, specific examples are included below. The examples are for illustrative purposes only and are not intended to limit the invention. Those of ordinary skill in the art will readily recognize parameters that can be changed or modified to yield essentially the same results.

### EXAMPLE

### Freezing Experiment

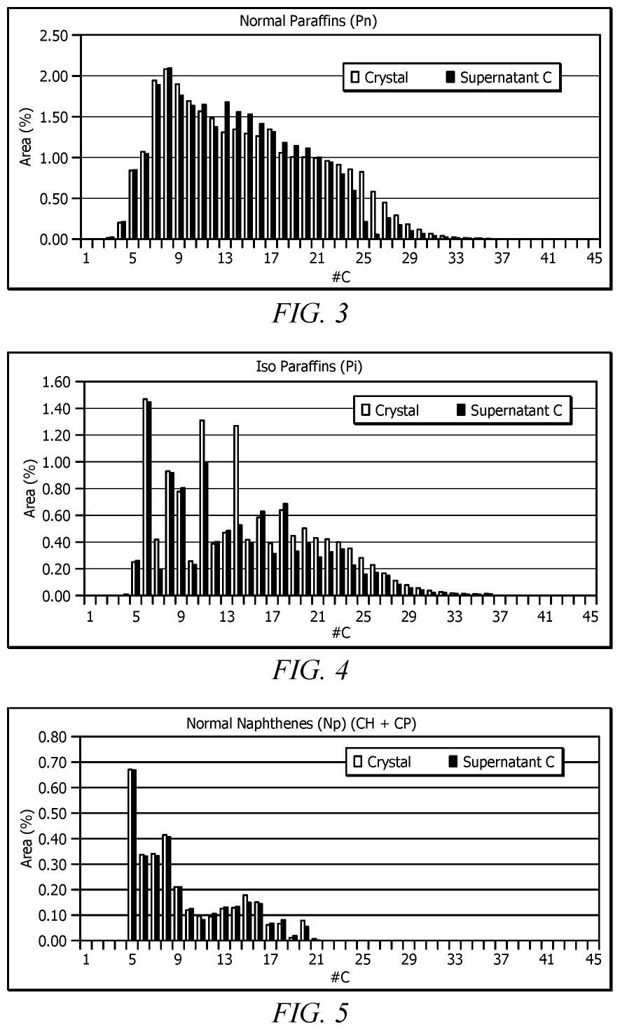

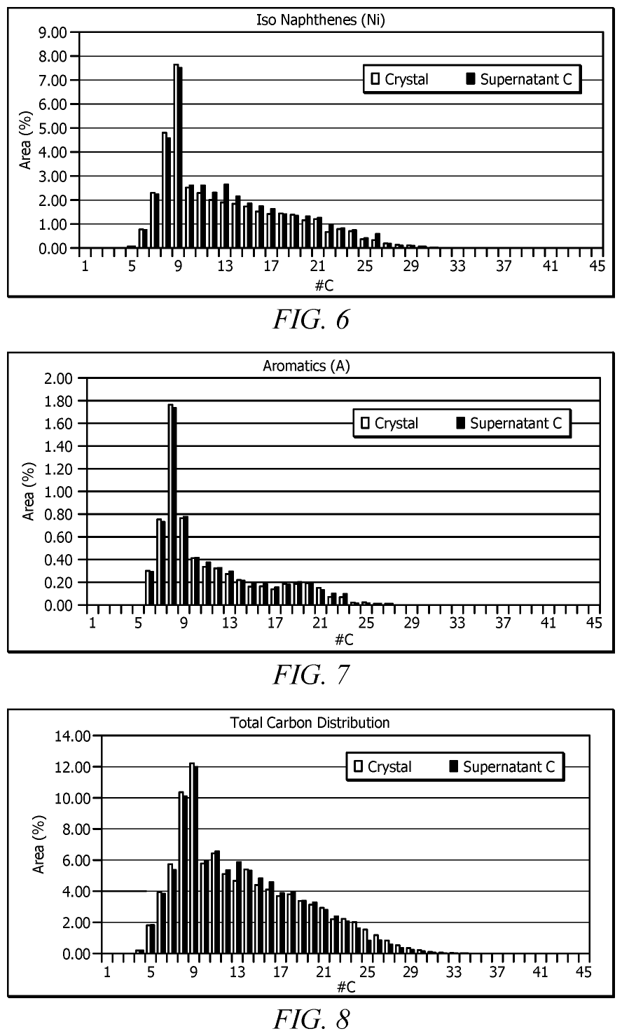

Pyoil was put in a refrigerator at 2° C. for 24 hours, which allowed the formation of a crystalline phase at the bottom and a liquid supernatant phase. Both were analyzed with Group-Typing (GC×GC) method. The analysis clearly shows, based on FIG. 3 to FIG. 8, that the crystalline/waxy layer contains more heavy components C21+.

In the context of the present invention, at least the following 11 embodiments are described. Embodiment 1 is a method of processing pyrolysis oil. The method includes flowing pyrolysis oil into a tank. The method further includes reducing the temperature of the pyrolysis oil to a temperature that causes paraffinic wax that is in solution in the pyrolysis oil to precipitate and form (1) paraffinic wax in solid form and (2) remaining pyrolysis oil in liquid form. The method still further includes pumping the remaining pyrolysis oil from the tank to a first location. In addition, the method includes heating the paraffinic wax in solid form to form paraffinic wax in liquid form, and pumping the paraffinic wax in liquid form to a second location. Embodiment 2 is the method of embodiment 1, wherein the pyrolysis oil is reduced to a temperature of −10° C. to 2° C. to precipitate the paraffinic wax. Embodiment 3 is the method of either of embodiments 1 or 2, wherein the pumping of the remaining pyrolysis oil is from a level no lower than 1 to 10 inches above the bottom of the tank. Embodiment 4 is the method of any of embodiments 1 to 3, wherein the reducing of the temperature of the pyrolysis oil comprises cooling, with a circulating coolant, (1) the tank and/or (2) coils within the tank so as to, in turn, cool the pyrolysis oil. Embodiment 5 is the method of any of embodiments 1 to 4, wherein the remaining pyrolysis oil has a cold filter plugging point (CFPP) of-5° C. to 5° C. Method 6 is the method of any of embodiments 1 to 5, wherein the paraffinic wax comprises straight chain saturated hydrocarbons with carbon atoms ranging from C18 to C36. Embodiment 7 is the method of any of embodiments 1 to 6, wherein the paraffinic has wax 80-90 wt. % normal paraffin content and 10-20 wt. % branched paraffins (iso-paraffins) and cycloparaffins. Embodiment 8 is the method of any of embodiments 1 to 7, wherein the tank is located in a bulk transportation vessel or vehicle. Embodiment 9 is the method of any of claims 1 to 8, wherein the first location is a feed tank for a first cracking unit and the method further includes cracking the remaining pyrolysis oil to form olefins at a COT in a range of 775 to 825° C., the remaining pyrolysis oil to form one or more olefins. Embodiment 10 is the method of any of embodiments 1 to 9, wherein the second location is a feed tank for a second cracking unit and the method further comprises cracking, at a COT in a range of 826 to 875° C., the paraffinic wax in liquid form to form one or more olefins. Embodiment 11 is the method of any of embodiments 1 to 10, wherein the olefins comprise one or more of ethylene and propylene.

The systems and processes described herein can also include various equipment that is not shown and is known to one of skill in the art of chemical processing. For example, some controllers, piping, computers, valves, pumps, heaters, thermocouples, pressure indicators, mixers, heat exchangers, and the like may not be shown. All embodiments described above and herein can be combined in any manner unless expressly excluded.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the 10 corresponding embodiments described herein may be utilized. Accordingly, the appended claims are intended to include within their scope such processes, machines, manufacture, compositions of matter, means, methods, or steps.

1. A method of processing pyrolysis oil, the method comprising:
flowing pyrolysis oil into a tank;
reducing the temperature of the pyrolysis oil to a temperature that causes paraffinic wax that is in solution in the pyrolysis oil to precipitate and form (1) paraffinic wax in solid form and (2) remaining pyrolysis oil in liquid form;
pumping the remaining pyrolysis oil from the tank to a first location;
heating the paraffinic wax in solid form to form paraffinic wax in liquid form; and
pumping the paraffinic wax in liquid form to a second location.

2. The method of claim 1, wherein the pyrolysis oil is reduced to a temperature of −10° C. to 2° C. to precipitate the paraffinic wax.

3. The method of claim 1, wherein the pumping of the remaining pyrolysis oil is from a level no lower than 1 to 10 inches above the bottom of the tank.

4. The method of claim 1, wherein the reducing of the temperature of the pyrolysis oil comprises cooling, with a circulating coolant, (1) the tank and/or (2) coils within the tank so as to, in turn, cool the pyrolysis oil.

5. The method of claim 1, wherein the remaining pyrolysis oil has a cold filter plugging point (CFPP) of −5° C. to 5° C.

6. The method of claim 1, wherein the paraffinic wax comprises straight chain saturated hydrocarbons with carbons atoms ranging from C18 to C36.

7. The method of claim 1, wherein the paraffinic wax is 80-90 wt. % normal paraffin content and 10-20 wt. %, branched paraffins (iso-paraffins) and cycloparaffins.

8. The method of claim 1, wherein the tank is located in a bulk transportation vessel or vehicle.

9. The method of claim 1, wherein the first location is a feed tank for a first cracking unit and the method further comprises:
cracking, the remaining pyrolysis oil to form olefins at a COT in a range of 775 to 825° C., the remaining pyrolysis oil to form one or more olefins.

10. The method of claim 1, wherein the second location is a feed tank for a second cracking unit and the method further comprises:
cracking, at a COT in a range of 826 to 875° C., the paraffinic wax in liquid form to form one or more olefins.

11. The method of claim 9, wherein the olefins comprise one or more of ethylene and propylene.

12. The method of claim 10, wherein the olefins comprise one or more of ethylene and propylene.

13. The method of claim 3, wherein the second location is a feed tank for a second cracking unit and the method further comprises:
cracking, at a COT in a range of 826 to 875° C., the paraffinic wax in liquid form to form one or more olefins.

14. The method of claim 4, wherein the second location is a feed tank for a second cracking unit and the method further comprises:
cracking, at a COT in a range of 826 to 875° C., the paraffinic wax in liquid form to form one or more olefins.

15. The method of claim 5, wherein the second location is a feed tank for a second cracking unit and the method further comprises:
cracking, at a COT in a range of 826 to 875° C., the paraffinic wax in liquid form to form one or more olefins.
